(19) United States
(12) Patent Application Publication
(10) Pub. No.: US 2010/0039388 A1
(43) Pub. Date: Feb. 18, 2010

(54) Keyboard apparatus integrated with touch input module

(76) Inventor: Allen Ku, Walnut, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 12/222,618

(22) Filed: Aug. 13, 2008

(51) Int. Cl. G09G 5/00

(52) U.S. Cl. 345/168

(57) ABSTRACT

A keyboard apparatus integrated with a touch input module is disclosed, and the touch input module functions as a handwriting mode and a cursor mode. Therefore, an input apparatus with more convenient and integrated functions is provided. According to the preferred embodiment, a keyboard controller for processing and transferring keystroke signals is included, and the touch input module is integrated into the keyboard. Further, a mode switching circuit is used to switch the touch input module to the handwriting mode or the cursor mode. Still further, a micro-controller in the touch input module is used to transfer the signals to a computer system through the keyboard controller. In particular, the touch input module jointly uses a power module and a communication port with the keyboard.

### BACKGROUND OF THE INVENTION

1. Field of the Invention

The present invention relates to a keyboard apparatus integrated with a touch input module, and more particularly to the keyboard apparatus integrating the touch input module supporting a cursor mode and a handwriting mode.

2. Description of Related Art

Keyboard and mouse are the most often used devices for computer input in general. With the development of the application software and a variety of the computer peripherals, a handwriting method or a mouse-like touch device further enhance the input way. Since the number of peripherals connected to computer systems is increasing, the connecting cables for the peripherals will more and more clutter computer tables.

Concerning the use of keyboards, users need to know well the arrangement of the keys for inputting data efficiently. Thus, a handwriting method can be a convenient input method for users who are bad at keyboard input. Reference is made to FIG. 1 which shows a schematic diagram of a computer system adopting a handwriting device. The shown keyboard 10 and handwriting device 14 connect with the computer system 12 at one time. The computer system 12 preferably supplies power to the keyboard 10 and handwriting device 14. The user uses a stylus 16 to write on a tablet of the handwriting device 14. Through the software installed in the computer system 12 tracks retrieved from the handwriting device 14 are recorded, and the tracks are recognized with a text-recognition program. Finally, the recognized text can be converted to normal text format.

FIG. 2 shows a conventional keyboard apparatus integrated with a touch pad mounted on a laptop. Besides the computer mouse as a used input device, the touch pad can be another often used cursor-controlled device, especially for a portable notebook computer. The shown computer system 20 is a notebook computer, wherein a touch sensitive module 24 is mounted on the keyboard module 22—including the touch pad for hand controlling the cursor.

Accordingly, as discussed above, the prior art still has some non-convenient disadvantages that could be improved. The present invention aims to resolve the drawbacks in the prior art.

### SUMMARY OF THE INVENTION

In order to integrate the input peripherals including a handwriting device and a touch sensitive control device to a computer system, the present invention provides a keyboard apparatus integrated with a touch input module. Through a driver installed in the computer system, the functions of the handwriting device and the touch sensitive control device are activated.

The preferred embodiment of the keyboard apparatus integrated with a touch input module includes a keyboard controller used for processing the input/output signals of the keyboard apparatus, and used to convert the scan code received from a keyboard scan circuit. After that, the signals are transmitted to the computer system through a communication unit.

The keyboard apparatus further integrates a touch input module which shares the power supply and the communication port of the original keyboard circuit. The claimed keyboard apparatus at least includes a touch pad, touch-sensing circuit and a micro-controller. After the touch-sensing circuit senses a touch event, a sensing signal is generated. The micro-controller then receives the sensing signal and converts it to a control signal. Next, the control signal is transmitted to the computer system by the keyboard controller and through the communication unit.

More particularly, the mentioned touch input module supports a cursor mode and a handwriting mode. The keyboard driver then generates the relevant command and drives a mode switching circuit to switch the operating mode of the touch input module.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of a conventional computer system applying the handwriting device;

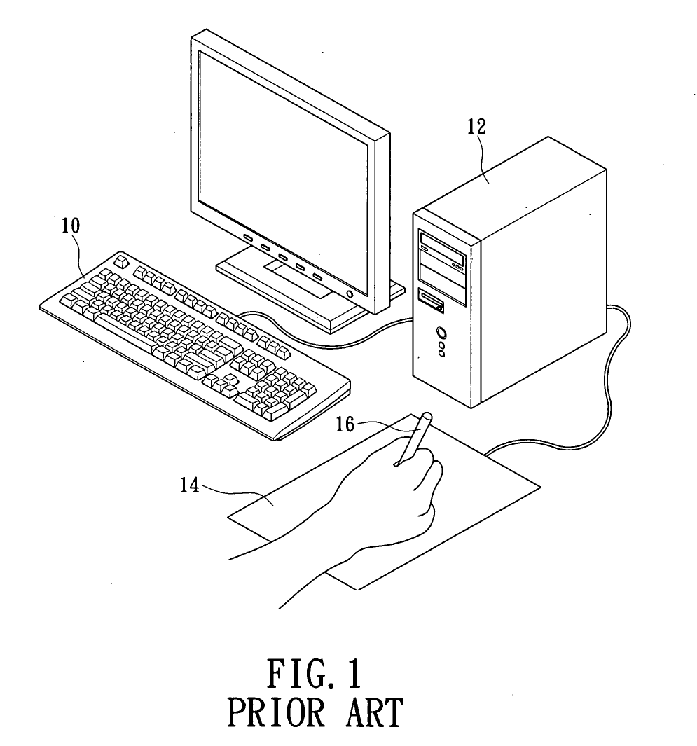

FIG. 2 shows a conventional keyboard apparatus integrated with a touch pad;

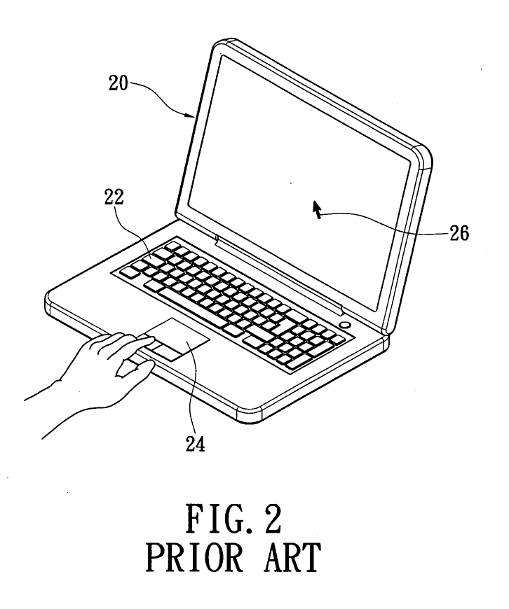

FIG. 3 shows an embodiment of the keyboard apparatus integrated with a touch input module of the present invention;

FIG. 4 shows a circuitry block diagram of the keyboard apparatus of the present invention.

### DETAILED DESCRIPTION OF PREFERRED EMBODIMENTS

The present invention is illustrated with a preferred embodiment and attached drawings. However, the invention is not intended to be limited thereby.

The present invention relates to a keyboard apparatus integrated with a touch input module. The touch input module is a more convenient and integral input device, and can function in a handwriting mode or a cursor mode. The appearance of the touch input module is a normal touch pad mounted on the keyboard apparatus, but it integrates the handwriting function by means of a mode switching circuit.

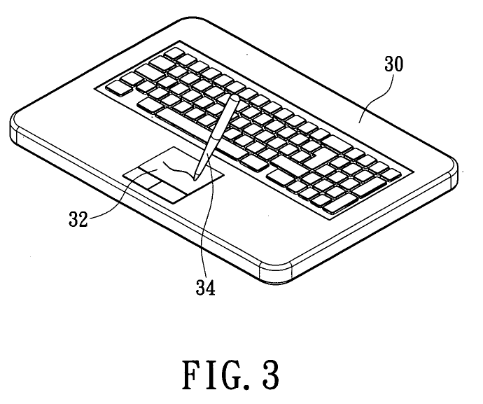

Reference is made to FIG. 3 showing a schematic diagram of the keyboard apparatus integrated with the touch input module of the preferred embodiment. The shown keyboard apparatus 30 includes a portion of the conventional keyboard in appearance, and also has a touch pad 32. This keyboard apparatus 30 integrates the circuit for the touch pad 32, thereby the user controls the cursor of the computer system through the touch pad 32. Alternatively, a stylus 34 is further used by the user writing on the touch pad 32.

The mentioned touch pad 32 can be alternatively driven by resistance-based or capacitance-based touch sensors. According to the theory of resistance-based touch sensors, the coordinates on an X-Y plane can be obtained in response to a negative voltage change. According to an exemplary example, when the resistance-based touch pad 32 is touched by a user's finger, the inside induced circuit is conducted to generate a sensing signal responsive to voltage's change. Thereby, the relevant coordinates can be found.

More, according to the theory of the capacitance-based touch sensor, the touch event will change an electric field to generate an electric current, wherein the original electric field is uniformly generated on a glass or other transparent panel with discharged electricity. A micro-controller embedded in the touch input module will find the coordinates after calculating the change of the current.

Because the claimed keyboard apparatus is integrated with the touch input module, but not the normal keyboard, a driver for the claimed keyboard apparatus is required to be installed in the computer system. The driver may transmit the signals generated from the keyboard apparatus 30, and further switch the functions made by the keyboard. Since the touch input module in the keyboard apparatus 30 supports the cursor mode and the handwriting mode, the relative control commands may be generated through a mode configuration and the driver. At this moment, the mode switching circuit is used to change the signaling mode between the touch pad 32 and the touch-sensing circuit in order to control the cursor or perform the handwriting.

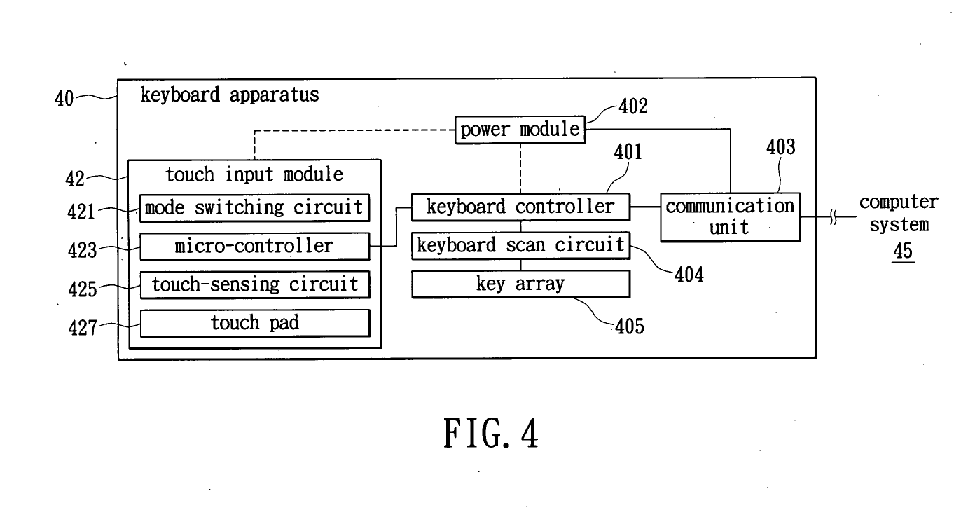

FIG. 4 shows the circuitry blocks of the preferred embodiment of the keyboard apparatus. The shown keyboard apparatus 40 may roughly be distinguished into a conventional keyboard module and the invention-claimed touch input module 42. The portion of the conventional keyboard module at least includes a keyboard controller 401, a power module 402, a communication unit 403, a keyboard scan circuit 404 and a key array 405. The portion of the touch input module 42 at least has a mode switching circuit 421, a micro-controller 423, a touch-sensing circuit 425 and a touch pad 427.

The mentioned keyboard controller 401 is used to process the input/output signals of the keyboard apparatus 40. Essentially, the keyboard controller 401 is to convert the scan code received from the keyboard scan circuit 404 in the key array 405, and to transmit the code to the computer system 45 via the communication unit 403. The communication unit 403 electrically connects with the keyboard controller 401, and outputs the signals generated by the keyboard apparatus 40 to the computer system 45 via a specific communication port (such as USB, PS/2).

The touch input module 42 electrically connects with the keyboard controller 401, and shares the power supply and the external communication port of the keyboard apparatus. The shared external communication port is preferably implemented by wired or wireless manner connected to the computer system 45. Since the touch pad 427 receives a touch event made by user's finger or stylus, the touch-sensing circuit 425 responsively generates induced signals. After that, the micro-controller 423 calculates the coordinates made by the touch event, and converts them to a control signal. The control signal is then transmitted to the computer system 45 by the keyboard controller 401.

More particularly, through the driver for the keyboard, the user may select a touch mode made by the touch input module 42 having the cursor mode and the handwriting mode. After the command for switching the modes is received by the mode switching circuit 421 of the touch input module 42, an operating mode of the touch input module 42 is switched by the micro-controller 423. At that moment, the micro-controller performs different signals' conversion responsive to the different modes. For example, the micro-controller 423 is required to convert the induced signal to a current cursor's position, such as the X-Y coordinates under the cursor mode. The micro-controller is further required to record the constant touching process sensed by the induced circuit. It is not only required to convert the coordinates, but also to record the handwriting tracks. In this case, a buffer memory (not shown) is required to store a series of changes of the coordinates during a period of time.

In particular, a program such as the driver in the computer system 45 is used to recognize the tracks as a normal text under the handwriting mode.

The conventional keyboard module and the invention-claimed touch input module 42 jointly share the power supplied by the power module 402. The power module 402 electrically connected to the keyboard controller 401 is mainly to manage the power supply of the keyboard apparatus 40. The touch input module is also electrically connected to the power module 402. The electrical power for the keyboard apparatus 40 is supplied from the computer system 45 through the communication port, or supplied from the independent batteries installed in the keyboard apparatus 40. Therefore, by means of the claimed keyboard apparatus, the cables linked to the computer system 45 can be reduced and also save the power management circuit due to the shared power scheme.

To sum up the description above, the keyboard apparatus with the touch input module integrates the functions fulfilled by a conventional keyboard and a touch input device. The touch input modes include a cursor mode and a handwriting mode. A driver is used to switch the modes. Moreover, an embedded keyboard controller is functioned to receive and process the scan code from the keyboard scan circuit, and to process the signals received from the touch input module. Those signals are sent out through the joint communication unit.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A keyboard apparatus integrated with a touch input module, comprising:
(a) a keyboard controller used to process the input/output signals of the keyboard apparatus, and to convert a scan code received from a keyboard scan circuit, and to transmit the scan code to a computer system;
(b) a communication unit electrically connected to the keyboard controller, used to output the signals generated by the keyboard apparatus to the computer system via a communication port;
(c) a touch input module electrically connected to the keyboard controller, supporting a cursor mode and a handwriting mode, transmitting the touch control signals to the computer system through the keyboard controller, and the touch input module further comprises:
(c1) a touch pad;
(c2) a touch-sensing circuit electrically connected with the touch pad, used to sense a touch event from the touch pad and generate a sensing signal; and
(c3) a micro-controller electrically connected with the touch-sensing circuit and the keyboard controller, used to receive the sensing signal and convert it to a control signal, and to transmit the control signal to the computer system through the keyboard controller and the communication unit;
wherein the touch input module and the circuits for the keyboard apparatus jointly use a power supply and the communication port.

2. The keyboard apparatus of claim 1, wherein the keyboard apparatus further comprises a power module, the power module electrically connects to the keyboard controller and manages the power for the keyboard apparatus.

3. The keyboard apparatus of claim 2, wherein the touch input module is electrically connected to the power module.

4. The keyboard apparatus of claim 1, wherein the touch input module further comprises a mode switching circuit that is used to switch the touch input module to the handwriting mode or the cursor mode.

5. The keyboard apparatus of claim 4, wherein the driver of the keyboard apparatus generates a switch signal to drive the mode switching circuit to switch the modes.

6. The keyboard apparatus of claim 1, wherein the communication unit transmits the signals to the computer system over wired or wireless communication.

7. The keyboard apparatus of claim 1, wherein the touch input module further comprises a buffer memory that is used to record a series of coordinates during a period of time.
